(19) United States
(12) Patent Application Publication
(10) Pub. No.: US 2017/0350326 A1
(43) Pub. Date: Dec. 7, 2017

(54) CONTROL DEVICE FOR INTERNAL COMBUSTION ENGINE

(71) Applicant: TOYOTA JIDOSHA KABUSHIKI KAISHA, Aichi-ken (JP)

(72) Inventors: Yushi SHIBAIKE, Susono-shi (JP); Yoshiyuki KAGEURA, Shizuoka-ken (JP); Satoru TANAKA, Yokohama-shi (JP)

(21) Appl. No.: 15/607,382

(22) Filed: May 26, 2017

(30) Foreign Application Priority Data
Jun. 6, 2016 (JP) 2016-112908

(51) Int. Cl. F02D 21/08; F02D 43/04; F02P 5/15; F02D 41/10; F02D 23/02; F02P 5/145; F02D 41/04; F02D 41/02; F02P 5/04; F02D 21/06; F02D 9/02

(52) U.S. Cl. CPC F02D 21/08; F02D 23/02; F02D 43/04; F02P 5/1502; F02D 41/10; F02D 2009/0235; F02D 2009/0222; F02D 2009/022; F02D 2009/0201; F02D 41/04; F02D 41/02; F02D 2009/0284; F02D 2021/083; F02P 5/04; F02D 21/06; F02P 5/145

(57) ABSTRACT

A control device predicts whether temporary reduction occurs to a charging efficiency of fresh air in an in-cylinder gas by an influence of an EGR rate of the in-cylinder gas, which increases later than increase of a charging efficiency of the in-cylinder gas, if a first arithmetic operation is applied to calculating a target throttle opening degree based on a target charging efficiency which is increasing, in a case of shifting to an acceleration operation, by using a prediction model expressing dynamic characteristics of an internal combustion engine. When it is predicted that temporary reduction occurs to the charging efficiency of the fresh air, the control device calculates the target throttle opening degree by a second arithmetic operation by which an increase speed of a throttle opening degree is restrained more than by the first arithmetic operation, instead of calculating the target throttle opening degree by the first arithmetic operation.

### CROSS-REFERENCE TO RELATED APPLICATION

This application is based on and claims the benefit of Japanese Patent Application No. 2016-112908, filed on Jun. 6, 2016, which is incorporated by reference herein in its entirety.

### BACKGROUND

### Field

The present invention relates to a control device for an internal combustion engine, and particularly relates to a control device for an internal combustion engine including a supercharger and an EGR device.

### Background Art

As described in JP 2014-152716 A, in an internal combustion engine where an outlet of an EGR passage is provided upstream of a compressor in an intake passage, at a time of start of an acceleration operation, it takes a lot of time for EGR gas that flows out into the intake passage from the outlet of the EGR passage to reach a combustion chamber first. Consequently, in a period until the EGR gas firstly reaches the combustion chamber, an EGR rate in the combustion chamber becomes excessively low with respect to a target EGR rate. When the EGR gas reaches the combustion chamber after a while, a fresh air amount in a cylinder is abruptly reduced because the EGR rate of the gas entering into the cylinder suddenly increases, whereby a torque level difference occurs.

In order to prevent this, the art proposed in JP 2014-152716 A estimates the EGR rate in the outlet of the EGR passage, and corrects a target throttle opening degree to a closing side more as the EGR rate is higher in at least the period until the EGR gas reaches the combustion chamber when the EGR rate is larger than a predetermined value.

### SUMMARY

In an acceleration operation, correcting the target throttle opening degree to a closing side leads to reduction in responsiveness of torque by retarding increase in a charging efficiency. Therefore, if an influence which an arrival delay of the EGR gas has on torque is small, the target throttle opening degree is not desired to be corrected to the closing side. In this regard, the above described conventional art does not perform correction of the target throttle opening degree when the EGR rate in the outlet of the EGR passage is the predetermined value or less.

To be sure, the EGR rate in the outlet of the EGR passage is one parameter that indicates the influence which the arrival delay of the EGR gas has on torque. However, it cannot be determined based on only the EGR rate in the outlet of the EGR passage whether or not the fresh air amount in a cylinder is temporarily reduced due to the arrival delay of the EGR gas and thereby a torque level difference occurs. Consequently, the above described conventional art has a possibility of performing correction of the target throttle opening degree although there is no possibility of occurrence of a torque level difference, and reducing responsiveness of torque needlessly.

The present disclosure is made in the light of the aforementioned problem, and has an object to provide a control device for an internal combustion engine capable of restraining a torque level difference due to an arrival delay of EGR gas without reducing responsiveness of torque more than necessary in an acceleration operation of the internal combustion engine.

A control device according to the present disclosure is a control device for controlling an internal combustion engine including a compressor disposed in an intake passage, a throttle disposed downstream from the compressor in the intake passage, and an EGR valve disposed in an EGR passage connecting an exhaust passage and an upstream side from the compressor in the intake passage. Further, the control device according to the present disclosure is a control device configured to operate the throttle so as to increase a charging efficiency of an in-cylinder gas, and operates the EGR valve to increase an EGR rate of the in-cylinder gas, in an acceleration operation. The control device according to the present disclosure is further configured as follows.

The control device according to the present disclosure comprises target charging efficiency determination means, target throttle opening degree arithmetic operation means, and prediction means. The control device according to the present disclosure may be configured as a computer including at least one processor and at least one memory. The computer may be configured to function as the target charging efficiency determination means, the target throttle opening degree arithmetic operation means, and the prediction means by at least one computer program stored in at least the one memory being executed by at least the one processor.

The target charging efficiency determination means is configured to determine a target charging efficiency that is a target value of the charging efficiency of the in-cylinder gas, and is configured to increase the target charging efficiency in accordance with a magnitude of acceleration that is requested to the internal combustion engine. The request for acceleration to the internal combustion engine may include a request that is inputted by a driver via an operation of an operation member. Further, a request for acceleration to the internal combustion engine may be supplied from a control system of a cruise control device, or a control system of an autonomous drive device. Note that in the present specification, a “charging efficiency of the in-cylinder gas” means a ratio of a mass of all gases in a cylinder, that is, all gases including fresh air and an EGR gas to a mass of air corresponding to a stroke volume. When a “charging efficiency” is simply mentioned, it means the charging efficiency of the in-cylinder gas, unless described otherwise. Further, when a “charging efficiency of fresh air” is mentioned, it means a ratio of a mass of fresh air entering into the cylinder to the mass of air corresponding to the stroke volume. Further, when a “charging efficiency of the EGR gas” is mentioned, it means a ratio of a mass of the EGR gas that enters into the cylinder to the mass of the air corresponding to the stroke volume.

The target throttle opening degree arithmetic operation means is configured to calculate a target throttle opening degree that is the target value of the opening degree of the throttle from the target charging efficiency. In detail, the target throttle opening degree arithmetic operation means is configured to be able to select calculation of the target throttle opening degree by a first arithmetic operation, and calculation of the target throttle opening degree by a second arithmetic operation by which an increase speed of a throttle opening degree is restrained more than by the first arithmetic operation. In more detail, the target throttle opening degree arithmetic operation means is configured to select calculation of the target throttle opening degree by the first arithmetic operation as standard setting, and select calculation of the target throttle opening degree by the second arithmetic operation when a condition for switch of selection that will be described later is established.

The second arithmetic operation may be to correct the target throttle opening degree calculated in the first arithmetic operation to a closing side. For example, if the first arithmetic operation is to calculate the throttle opening degree for achieving the target charging efficiency as the target throttle opening degree, in the second arithmetic operation, the target charging efficiency may be corrected to a decreasing side, and the throttle opening degree for achieving the corrected target charging efficiency may be calculated as the target throttle opening degree. Acquiring the target EGR rate, calculating the estimated EGR rate of all the gases passing through the intake valve, and subtracting the charging efficiency corresponding to the difference between the target EGR rate and the estimated EGR rate from the target charging efficiency may be performed as a procedure of correcting the target charging efficiency to the decreasing side.

The prediction means is configured to predict whether the condition for switch to calculation of the target throttle opening degree by the second arithmetic operation from calculation of the target throttle opening degree by the first arithmetic operation is established by using the prediction model expressing the dynamic characteristics of the internal combustion engine. In detail, the condition for switching selection is that temporary reduction occurs to the charging efficiency of the fresh air by an influence of the EGR rate of the in-cylinder gas which increases later than increase of the charging efficiency of the in-cylinder gas, if the first arithmetic operation is applied to calculation of the target throttle opening degree based on the target charging efficiency which is increasing, in a case of shifting to the acceleration operation. That is, when temporary reduction of the charging efficiency of the fresh air that is the cause of a torque level difference occurs when calculation of the target throttle opening degree by the first arithmetic operation is also continued in the acceleration operation, switch to calculation of the target throttle opening degree by the second arithmetic operation is performed.

Whether temporary reduction occurs to the charging efficiency of the fresh air may be predicted by a procedure as follows, for example. First, an increase speed of the charging efficiency of the in-cylinder gas, and an increase speed of the charging efficiency of the EGR gas, which are obtained when the throttle is operated by using the target throttle opening degree which is calculated by the first arithmetic operation, are predicted by using a prediction model. Subsequently, when the increase speed of the charging efficiency of the EGR gas is higher than the increase speed of the charging efficiency of the in-cylinder gas, it is determined that temporary reduction occurs to the charging efficiency of the fresh air. A difference between the increase speed of the charging efficiency of the in-cylinder gas and the increase speed of the charging efficiency of the EGR gas corresponds to an increase speed of the charging efficiency of the fresh air. Therefore, when the increase speed of the charging efficiency of the EGR gas is higher than the increase speed of the charging efficiency of the in-cylinder gas, the increase speed of the charging efficiency of the fresh air is negative, and this shows that the charging efficiency of the fresh air is reduced.

The prediction model for use in prediction may be configured to include at least the throttle opening degree in an input, and include at least the charging efficiency of the fresh air or the increase speed of the charging efficiency of the fresh air in an output. Further, the prediction model may be configured as a combination of a plurality of element models. For example, the prediction model may be configured by combining a supercharging model in which a relationship between a flow rate of a gas passing through the intake valve and a compressor flow rate is modeled, an intake model in which a relationship between the compressor flow rate, the throttle opening degree and the flow rate of the gas passing through the intake valve is modeled, and an EGR model in which a relationship between the compressor flow rate, an EGR valve opening degree and the EGR rate is modeled.

The supercharging model, the intake model, and the EGR model may be each configured as a combination of a plurality of element models. The supercharging model may be configured by combining a turbo rotational speed model in which a relationship between the flow rate of the gas passing through the intake valve and a turbo rotational speed is modeled, and a compressor model in which a relationship between the turbo rotational speed, a compressor downstream pressure and the compressor flow rate is modeled, for example. Further, an air cleaner model in which a relationship between a flow rate of air which is taken into the intake passage and a pressure loss in an air cleaner is modeled is included in the supercharging model, and pressure of air after passing through the air cleaner may be used as an input to the compressor model. Further, if the internal combustion engine includes an air bypass valve, an air bypass valve model in which a relationship between the operation state of the air bypass valve and the flow rate of a gas that is returned to upstream of the compressor is modeled may be included in the supercharging model. If the internal combustion engine includes an actuator for controlling the turbo rotational speed like a wastegate valve or a variable nozzle, an operation state of the actuator may be used as one of inputs to the turbo rotational speed model, and an actuator response model in which a response characteristic of the actuator are modeled may be included in the supercharging model.

The intake model may be configured by combining a throttle model in which a relationship between an upstream pressure of the throttle, a downstream pressure of the throttle, the throttle opening degree, and a flow rate of gas passing through the throttle is modeled, an intake manifold model in which a relationship between a flow rate of gas flowing into an intake manifold, a flow rate of gas flowing out of the intake manifold, and a pressure of the intake manifold is modeled, and an intake valve model in which a relationship between the pressure of the intake manifold and the flow rate of the gas passing through the intake valve is modeled, for example. Further, an intercooler model in which a relationship between a flow rate of gas flowing into an intercooler, a flow rate of gas flowing out of the intercooler, and an outlet pressure of the intercooler is modeled may be included in the intake model.

The EGR model may be configured by combining an EGR valve model in which a relationship between the compressor flow rate, the EGR valve opening degree and the EGR rate is modeled, and an EGR diffusion model in which a change with respect to time of the EGR rate by diffusion of the EGR gas in a path from the EGR valve to the intake valve is modeled, for example.

According to the control device for an internal combustion engine according to the present disclosure, if it is predicted that temporary reduction occurs in the charging efficiency of fresh air by applying the first arithmetic operation to calculation of the target throttle opening degree in an acceleration operation by the prediction model expressing the dynamic characteristics of the internal combustion engine, the target throttle opening degree is calculated in accordance with the second arithmetic operation by which the increase speed of the throttle opening degree is restrained more than by the first arithmetic operation, instead of the first arithmetic operation. Consequently, the torque level difference due to a delay in arrival of the EGR gas can be restrained without reducing responsiveness of torque more than necessary.

### BRIEF DESCRIPTION OF DRAWINGS

FIG. 1 is a diagram illustrating a configuration outline of an internal combustion engine according to the present disclosure;

FIG. 2 is a block diagram illustrating functions included by the control device according to the present disclosure;

FIG. 3 is a diagram illustrating an example of changes with time of a charging efficiency of all gases, a charging efficiency of fresh air and a charging efficiency of an EGR gas at a time of an acceleration operation;

FIG. 4 is a diagram illustrating an example of a relationship between a target EGR rate and an estimated EGR rate at the time of an acceleration operation;

FIG. 5 is a diagram illustrating another example of changes with time of the charging efficiency of all gases, the charging efficiency of fresh air and the charging efficiency of the EGR gas at the time of an acceleration operation;

FIG. 6 is a flowchart illustrating a control flow of throttle opening degree control according to the present disclosure;

FIG. 7 is a time chart illustrating an example of an operation of the internal combustion engine in a case where the throttle opening degree control according to the present disclosure is executed;

FIG. 8 is a time chart illustrating another example of the operation of the internal combustion engine in the case where the throttle opening degree control according to the present disclosure is executed;

FIG. 9 is a block diagram illustrating an example of a configuration of a prediction model for use in prediction of a change speed of the charging efficiency of fresh air; and

FIG. 10 is a block diagram illustrating another example of the configuration of the prediction model for use in prediction of the change speed of the charging efficiency of fresh air.

### DETAILED DESCRIPTION

Hereinafter, an embodiment of the present invention will be described with reference to the drawings. Note that when the numerals of the numbers, the quantities, the amounts, the ranges and the like of the respective elements are mentioned in the embodiment shown as follows, the present invention is not limited to the mentioned numerals unless specially explicitly described otherwise, or unless the invention is explicitly specified by the numerals theoretically. Further, the structures, steps and the like that are described in the embodiment shown as follows are not always indispensable to the invention unless specially explicitly shown otherwise, or unless the invention is explicitly specified by the structures, steps and the like theoretically.

### 1. Configuration of Internal Combustion Engine

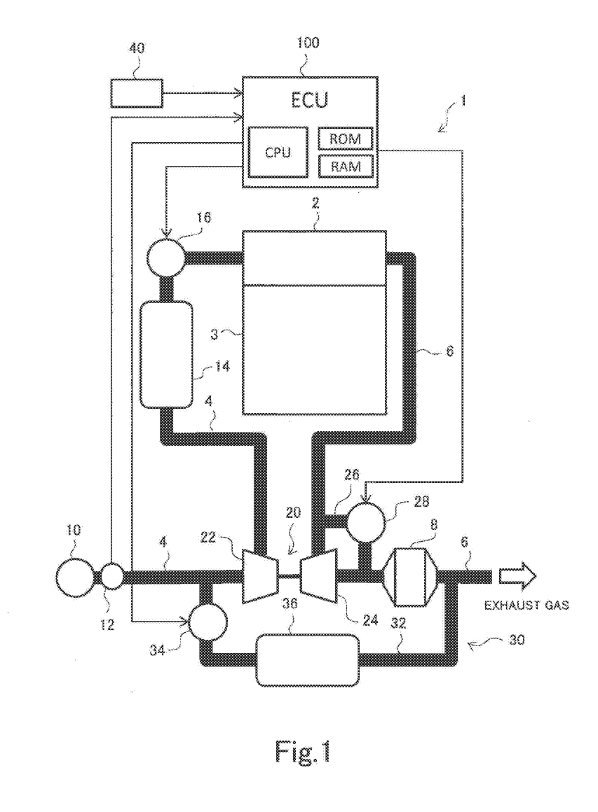

FIG. 1 is a diagram illustrating a configuration outline of an internal combustion engine according to the embodiment. The internal combustion engine (hereinafter, simply described as an engine) 1 is a spark ignition type engine, and has an engine block 3, and an engine head 2 that is disposed on the engine block 3. In the engine block 3, a plurality of cylinders not illustrated are formed. In the engine head 2, a number of devices and actuators such as an intake valve and a valve mechanism that drives the intake valve, an exhaust valve and a valve mechanism that drives the exhaust valve, an ignition plug and a fuel injection valve that are not illustrated are mounted.

An intake passage 4 and an exhaust passage 6 are connected to the engine head 2. In the intake passage 4, an air cleaner 10, an air flow sensor 12, a compressor 22, an intercooler 14 and an electronic control type throttle 16 are disposed in this order from upstream of the intake passage 4 to the engine head 2. In the exhaust passage 6, a turbine 24 that configures a turbocharger 20 with the compressor 22, and a catalyst device 8 are disposed in this order from the engine head 2 to downstream. Further, in the exhaust passage 6, a bypass passage 26 that bypasses the turbine 24 is provided, and a wastegate valve 28 is disposed in the bypass passage 26.

The engine 1 includes an EGR device 30 that recirculates a part of exhaust gas to the intake passage 4 from the exhaust passage 6. The EGR device 30 is configured by an EGR passage 32, an EGR cooler 36 and an EGR valve 34. The EGR passage 32 connects the exhaust passage 6 downstream of the catalyst device 8 and the intake passage 4 upstream of the compressor 22. The EGR cooler 36 is provided in the EGR passage 32, and cools exhaust gas flowing in the EGR passage 32, that is, EGR gas. The EGR valve 34 is provided in the EGR passage 32 downstream from the EGR cooler 36 in a direction of a flow of the EGR gas.

The engine 1 includes a control device 100. To the control device 100, various sensors including an accelerator opening degree sensor 40 are connected in addition to the air flow sensor 12. The control device 100 controls an operation of the engine 1 by operating various devices and actuators included by the engine 1, based on information obtained with these sensors. The control device 100 is an ECU (Electronic Control Unit) having at least one CPU, at least one ROM, and at least one RAM. Note that the control device 100 may be configured by a plurality of ECUs. In the control device 100, computer programs stored in the ROM are loaded onto the RAM, and are executed by the CPU, whereby various functions relating to engine control are realized.

### 2. Functions Included by Control Device

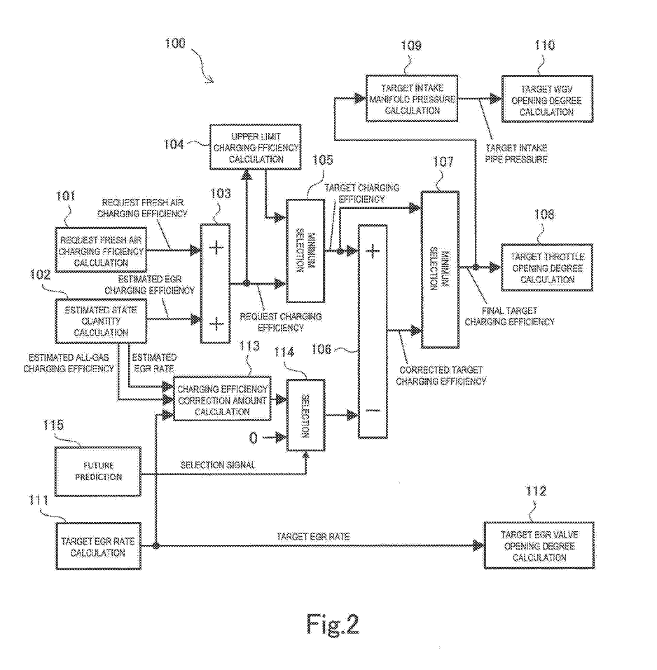

FIG. 2 is a diagram in which a function relating to control of an opening degree of the throttle 16, a function relating to control of an opening degree of the EGR valve 34, and a function relating to control of an opening degree of the wastegate valve 28 are especially extracted from the various functions included by the control device 100 and are expressed in blocks. Although the control device 100 includes various functions other than these functions, illustration of the various functions is omitted. In FIG. 2, arithmetic operation units 101 to 115 are assigned to the respective functions. Note that the respective arithmetic operation units 101 to 115 do not exist as hardware, but are virtually realized when exclusive software stored in the ROM is executed in the CPU. Hereinafter, the functions relating to throttle opening degree control, EGR valve opening degree control and wastegate valve opening degree control that the control device 100 has will be described with use of FIG. 2.

The arithmetic operation unit 101 calculates a charging efficiency of fresh air requested of the engine 1 (hereinafter, described as a request fresh air charging efficiency). In the calculation, a map in which the request fresh air charging efficiency is related to the accelerator opening degree is used. By referring to the map, the request fresh air charging efficiency corresponding to the accelerator opening degree is obtained. However, when a vehicle includes a cruise control device, the request fresh air charging efficiency is determined in accordance with a magnitude of acceleration required by a control system of the cruise control device. Further, when the vehicle includes an autonomous drive device, the request fresh air charging efficiency is determined in accordance with a magnitude of acceleration requested by a control system of the autonomous drive device.

An arithmetic operation unit 102 calculates estimated values of various state quantities of the engine 1. The estimated values that are calculated include an estimated value of a charging efficiency of an in-cylinder gas, that is, all gases (hereinafter, described as an estimated all-gasses charging efficiency), an estimated value of an EGR rate of a gas passing through the intake valve (hereinafter, described as an estimated EGR rate), and an estimated value of a charging efficiency of the EGR gas in the in-cylinder gas (hereinafter, described as an estimated EGR charging efficiency). The estimated values of these state quantities are calculated by using an estimation model in which dynamic characteristics of the engine 1 are modeled. The estimation model has a common configuration to a prediction model that will be described later. In the prediction model that will be described later, change of the state quantities in a predetermined prediction period in the future from a present point of time is predicted, whereas in the calculation by the estimation model, estimated values of the state quantities at the present point of time are calculated by using an engine model of substantially the same configuration as calculation by the prediction model.

An arithmetic operation unit 103 calculates a charging efficiency that is requested of the engine 1 (hereinafter, described as a request charging efficiency) by adding up the request fresh air charging efficiency calculated by the arithmetic operation unit 101, and the estimated EGR charging efficiency calculated by the arithmetic operation unit 102. Since introduction of fresh air is inhibited by introduction of the EGR gas, the request charging efficiency which is a charging efficiency of all of in-cylinder gases including not only fresh air but also the EGR gas is calculated in order to ensure a necessary amount of fresh air (an amount of fresh air that is requested) by additionally opening the throttle 16.

An arithmetic operation unit 104 calculates an upper limit value of a charging efficiency with the state of the engine 1 taken into consideration (hereinafter, described as an upper limit charging efficiency). In detail, the upper limit charging efficiency is a maximum charging efficiency that is realizable at a next arithmetic operation time after one control period. A value that can be obtained by adding a maximum change amount of the charging efficiency per one control period to the estimated all-gas charging efficiency may be set as the upper limit charging efficiency. In the calculation, a map in which the upper limit charging efficiency is related to information indicating the state of the engine 1 at present such as the engine speed and the intake air temperature is used. Alternatively, the upper limit value of the charging efficiency may be calculated by using the aforementioned engine model.

An arithmetic operation unit 105 selects smaller one of the request charging efficiency calculated by the arithmetic operation unit 103 and the upper limit charging efficiency calculated by the arithmetic operation unit 104. Subsequently, the arithmetic operation unit 105 determines the selected charging efficiency as the target charging efficiency to be given to the engine 1. The request charging efficiency is only an unilateral request from a driver or the control system of the autonomous drive device or the like, and therefore may be an unrealistic value in the state of the engine 1 at present. In the arithmetic operation unit 105, the target charging efficiency that is realizable by the engine 1 is determined by restricting the request charging efficiency to a realistic value with the state of the engine 1 taken into consideration. In particular, at the acceleration operation time in which the request charging efficiency drastically increases, the request charging efficiency tends to be larger than the upper limit charging efficiency, and the target charging efficiency is restricted by the upper limit charging efficiency.

An arithmetic operation unit 107 selects a smaller one of the target charging efficiency determined by the arithmetic operation unit 105, and a corrected target charging efficiency that is calculated by an arithmetic operation unit 106 that will be described later. Subsequently, the arithmetic operation unit 107 determines the selected charging efficiency as a final target charging efficiency. Consequently, if the corrected target charging efficiency calculated by the arithmetic operation unit 106 is smaller than the original target charging efficiency, the corrected target charging efficiency is determined as the final target charging efficiency, but otherwise, the target charging efficiency is directly determined as the final target charging efficiency.

An arithmetic operation unit 108 calculates a target opening degree of the throttle 16 (hereinafter, described as a target throttle opening degree) based on the final target charging efficiency determined by the arithmetic operation unit 107. In calculation of the target throttle opening degree, an inverse model of an intake model in which a response of the charging efficiency to an operation of the throttle 16 is modeled by a physical expression is used. The intake model may be configured by combining a throttle model, an intake manifold model and an intake valve model (each of the models will be described in detail later). By solving the inverse model of the intake mode, the target throttle opening degree for achieving the final target charging efficiency with high responsiveness is obtained.

The target throttle opening degree which is calculated by the arithmetic operation unit 108 is outputted to a driver that operates the throttle 16. The arithmetic operation unit 108 provides a predetermined delay time period (approximately 32 msec corresponding to several control periods, for example) for throttle delay control in a period from calculation of the target throttle opening degree until output. The target throttle opening degree can be regarded as a throttle opening degree in the future by the delay time period. If the future throttle opening degree is found, a charging efficiency at that point of time can be also predicted, and from the predicted charging efficiency, an amount of fuel which should be injected by the fuel injection valve can be accurately calculated. Consequently, the target throttle opening degree calculated by the arithmetic operation unit 108 is also used in prediction of the charging efficiency at the point of time in the future by the delay time period, in the throttle delay control.

An arithmetic operation unit 109 calculates a target intake manifold pressure based on the final target charging efficiency determined by the arithmetic operation unit 107. A flow rate of the gas passing through the intake valve is calculated from the final target charging efficiency and the engine speed. In calculation of the target intake manifold pressure, an inverse model of the intake valve model in which a relationship between the flow rate of the gas passing through the intake valve and the intake manifold pressure is modeled is used. By solving the inverse model of the intake valve model, the target intake manifold pressure for achieving the final target charging efficiency with high responsiveness is obtained.

An arithmetic operation unit 110 calculates a target opening degree of the wastegate valve 28 (hereinafter, described as a target WGV opening degree) based on the target intake manifold pressure determined by the arithmetic operation unit 109. A pressure that is obtained by adding a predetermined pressure loss to an intake manifold pressure (a pressure at a downstream side of the throttle) is a supercharging pressure (a pressure at an upstream side of the throttle), and the supercharging pressure depends on the opening degree of the wastegate valve 28. Therefore, in determination of the target WGV opening degree, a map in which the target WGV opening degree is related to information on the supercharging pressure and the like is used.

An arithmetic operation unit 111 determines a target EGR rate that is given to the engine 1. In determination of the target EGR rate, a map in which the target EGR rate is related to information indicating an operation state of the engine 1 at present (for example, the engine speed and the charging efficiency) is used.

An arithmetic operation unit 112 calculates a target opening degree of the EGR valve 34 (hereinafter, described as a target EGR valve opening degree) based on the target EGR rate determined by the arithmetic operation unit 111. In determination of the target EGR valve opening degree, a map in which the target EGR valve opening degree is related to the information on the target EGR rate and the like is used.

The arithmetic operation unit 106 performs correction to the target charging efficiency calculated by the arithmetic operation unit 105. The correction is performed to restrain a torque level difference that occurs at the time of acceleration of the engine 1.

The torque level difference will be specifically described. At the start of an acceleration operation, the throttle 16 is opened significantly first in accordance with a magnitude of acceleration that is requested by the driver or the control system of the autonomous drive device or the like. Furthermore, in a case of shifting to a high load from a low load with no EGR gas being introduced, the target EGR rate is set at a value larger than zero halfway through the shift, in order to enhance fuel consumption performance and exhaust gas performance, and introduction of the EGR gas is started.

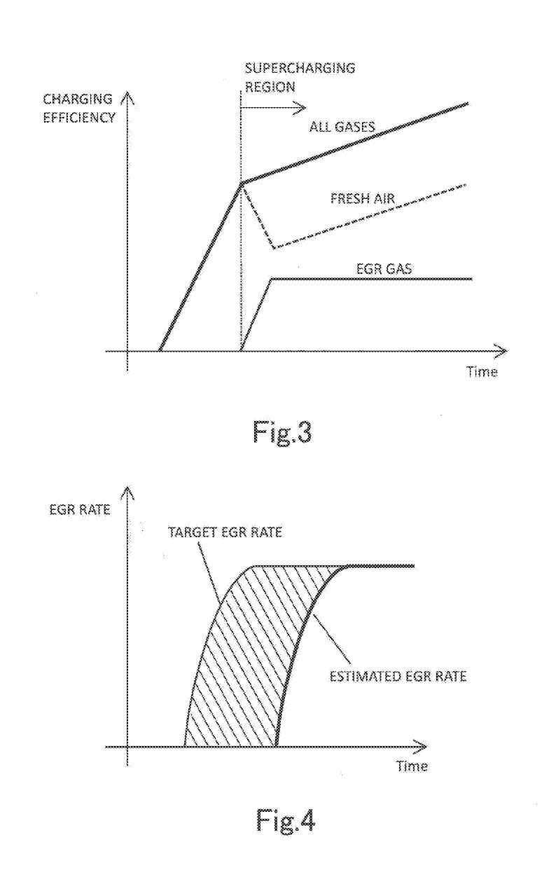

FIG. 3 is a diagram illustrating an example of changes with time of the charging efficiency of the in-cylinder gas (hereinafter, described as the charging efficiency of all the gases) at the time of an acceleration operation, the charging efficiency of fresh air in the in-cylinder gas, and the charging efficiency of the EGR gas in the in-cylinder gas. Since there is some distance from the EGR valve 34 and the combustion chamber, a state where no EGR gas reaches the combustion chamber continues for some period from the start of acceleration, and only the charging efficiency of fresh air increases. When the EGR gas reaches the combustion chamber through the intake valve after a while, the charging efficiency of the EGR gas increases from that point of time, and the charging efficiency of fresh air is reduced by an increase amount of the charging efficiency of the EGR gas. The reduction in the charging efficiency of fresh air is only temporary, and the charging efficiency of fresh air soon changes to increase from reduction, as a result that the target charging efficiency further increases and supercharging by the turbocharger 20 is started. However, as a result that the charging efficiency of fresh air is reduced even temporarily, the torque of the engine 1 is temporarily reduced or is stagnate halfway through the increase of the torque. That is, a torque level difference occurs.

In order to restrain the torque level difference like this, in the embodiment, the target charging efficiency is set to be lower than a value determined from the upper limit charging efficiency to restrain introduction of fresh air into the combustion chamber, until the influence of a delay in arrival of the EGR gas is eliminated.

FIG. 4 is a diagram illustrating an example of a relationship between the target EGR rate at the time of an acceleration operation, and the estimated EGR rate of the gas passing through the intake valve. There is a time delay corresponding to a time period that is taken until the EGR gas passing through the EGR valve 34 reaches the combustion chamber, until the estimated EGR rate changes after the target EGR rate changes. In that period, the target EGR rate is larger than the estimated EGR rate, and a difference between both of them becomes larger as the target EGR rate increases. When the estimated EGR rate starts to increase shortly, the difference between the target EGR rate and the estimated EGR rate becomes gradually small, and the difference between both of them becomes zero when the estimated EGR rate catches up with the target EGR rate. In this embodiment, the target charging efficiency is corrected by subtracting the charging efficiency corresponding to the difference between the target EGR rate and the estimated EGR rate from the target charging efficiency, and the target throttle opening degree is calculated based on the corrected target charging efficiency. In this way, an increase speed of the charging efficiency of fresh air is restrained just before the EGR gas reaches the combustion chamber, and the charging efficiency of fresh air can be prevented from abruptly reducing when the EGR gas reaches the combustion chamber.

Returning to FIG. 2 again, explanation of the functions included by the control device 100 will be continued. An arithmetic operation unit 113 is provided to calculate a charging efficiency correction amount that is used in correction of the target charging efficiency by the arithmetic operation unit 106. The arithmetic operation unit 113 calculates the charging efficiency correction amount for use in correction of the target charging efficiency based on the target EGR rate calculated by the arithmetic operation unit 111, the estimated EGR rate and the estimated all-gas charging efficiency that are calculated in the arithmetic operation unit 102. The charging efficiency correction amount is defined as the charging efficiency corresponding to the difference between the target EGR rate and the estimated EGR rate. By multiplying the difference between the target EGR rate and the estimated EGR rate by the estimated all-gas charging efficiency, the arithmetic operation unit 113 calculates the charging efficiency correction amount.

The charging efficiency correction amount calculated by the arithmetic operation unit 113 is inputted to the arithmetic operation unit 106 via an arithmetic operation unit 114. When the charging efficiency correction amount calculated by the arithmetic operation unit 113 is inputted to the arithmetic operation unit 106 by the arithmetic operation unit 114, the arithmetic operation unit 106 corrects the target charging efficiency by subtracting the charging efficiency correction amount from the target charging efficiency calculated by the arithmetic operation unit 105, and outputs the corrected target charging efficiency that is obtained thereby to the arithmetic operation unit 107.

The arithmetic operation unit 114 can select an output from the charging efficiency correction amount calculated by the arithmetic operation unit 113 and a zero value. When the zero value is selected as the output of the arithmetic operation unit 114, correction of the target charging efficiency by the charging efficiency correction amount is not performed. Standard setting of the output of the arithmetic operation unit 114 is a zero value, and only in a period in which a switching signal is inputted from the arithmetic operation unit 115, the output of the arithmetic operation unit 114 is switched from the zero value to the charging efficiency correction amount calculated by the arithmetic operation unit 113.

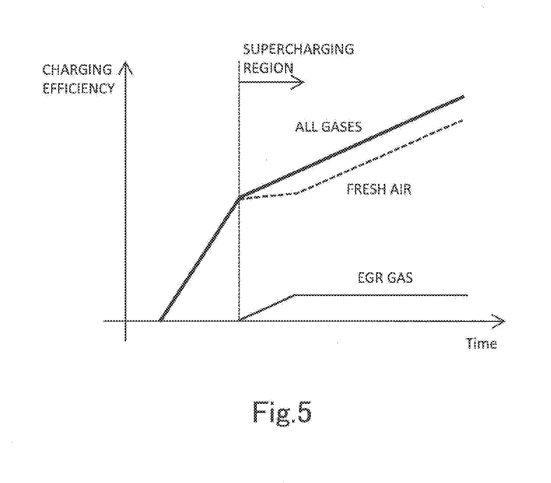

The arithmetic operation unit 115 inputs the switching signal to the arithmetic operation unit 114 only when a predetermined condition for switching selection is established. The condition for switching selection is that it is predictable that temporary reduction occurs to the charging efficiency of fresh air by the influence of the EGR rate of the in-cylinder gas which increases later than increase in the charging efficiency if the target throttle opening degree is calculated from the target charging efficiency which is not corrected in the case of shifting to the acceleration operation. In other words, the arithmetic operation unit 115 does not input the switching signal to the arithmetic operation unit 114 if there is no possibility of the torque level difference even if the target charging efficiency calculated by the arithmetic operation unit 105 is directly used in calculation of the target throttle opening degree. Hereinafter, the case having no possibility of a torque level difference will be described in detail by using FIG. 5.

FIG. 5 is a diagram illustrating another example of the changes with time of the charging efficiency of all the gases, the charging efficiency of fresh air and the charging efficiency of the EGR gas at the time of an acceleration operation. In this example, the state where no EGR gas reaches the combustion chamber also continues for a while from the start of acceleration, so that after the charging efficiency of all of the gases starts to increase, the charging efficiency of the EGR gas starts to increase later than increase of the charging efficiency of all the gases. Increase of the charging efficiency of fresh air is restrained by the increase amount of the charging efficiency of the EGR gas. However, when the increase speed of the charging efficiency of the EGR gas is gradual, temporary reduction occurs to the increase speed of the charging efficiency of the fresh air, but the charging efficiency itself of the fresh air continues to increase without reducing. When the charging efficiency of the fresh air continues to increase, a state where a torque level difference due to reduction in torque of the engine 1 occurs is not brought about. Therefore, if the charging efficiency of the fresh air changes as in the example illustrated in FIG. 5, it is more preferable to control the opening degree of the throttle 16 in accordance with the target charging efficiency than correcting the target charging efficiency based on the charging efficiency corresponding to the difference between the target EGR rate and the estimated EGR rate, in the respect that responsiveness of torque to the request of acceleration can be ensured.

Returning to FIG. 2 again, the arithmetic operation unit 115 will be described. When the operation is shifted to the acceleration operation, the arithmetic operation unit 115 predicts whether temporary reduction occurs to the charging efficiency of the fresh air when correction of the target charging efficiency is not performed, by using a prediction model that will be described later. Whether temporary reduction occurs to the charging efficiency of the fresh air can be predicted by comparing the increase speed of the charging efficiency of all the gases, and the increase speed of the charging efficiency of the EGR gas. When the increase speed of the charging efficiency of the EGR gas is higher than the increase speed of the charging efficiency of all the gases, the increase speed of the charging efficiency of the fresh air, which is the difference between the increase speed of the charging efficiency of all the gases and the increase speed of the charging efficiency of the EGR gas, becomes a negative value. The increase speed of the charging efficiency of the fresh air being negative means that the charging efficiency of the fresh air reduces at each cycle.

In detail, the arithmetic operation unit 115 firstly predicts a change of the throttle opening degree in the case of not performing correction of the target charging efficiency. When the change is within a delay time period of the throttle delay control, the target throttle opening degree which is calculated from the target charging efficiency which is not corrected can be regarded as a future throttle opening degree. As for the throttle opening degree of the future later than the delay time period of the throttle delay control, prediction may be performed on the assumption that the change speed of the throttle opening degree is constant. The arithmetic operation unit 115 predicts a change of the increase speed of the charging efficiency of all the gases and a changes of the increase speed of the charging efficiency of the EGR gas in the predetermined prediction period of the future later than the present point of time, based on the predicted throttle opening degree. When the increase speed of the charging efficiency of the EGR gas is predicted to be larger than the increase speed of the charging efficiency of all the gases at least once, within the prediction period, the arithmetic operation unit 115 inputs a switching signal to the arithmetic operation unit 114 in a period until the acceleration operation is ended.

Contents of the arithmetic units 101 to 115 included by the control device 100 are as described above. In relation with the claims of the present application, the arithmetic operation units 101, 102, 103, 104 and 105 configure target charging efficiency determination means. Further, the arithmetic operation units 106, 107, 108, 113 and 114 configure target throttle opening degree arithmetic operation means. When the output of the arithmetic operation unit 114 is zero, it indicates that a first arithmetic operation is selected in the target charging efficiency determination means, and when the output of the arithmetic operation unit 114 is the input value from the arithmetic operation unit 113, it indicates that a second arithmetic operation is selected in the target charging efficiency determination means. The arithmetic operation unit 115 configures prediction means.

### 3. Control Flow of Throttle Opening Degree Control

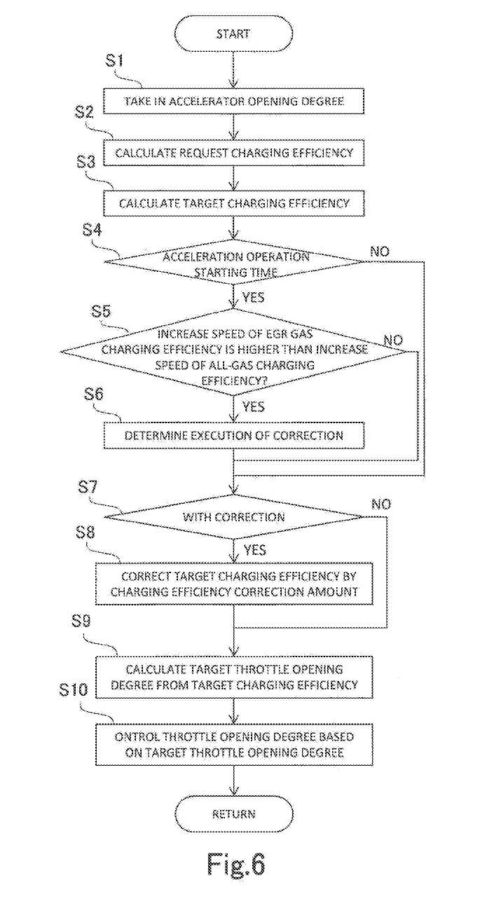

Throttle opening degree control to restrain the torque level difference at the time of an acceleration operation is performed by the control device 100 which is configured as described above. FIG. 6 is a flowchart illustrating a control flow of the throttle opening degree control that is executed by the control device 100.

In step S1, the control device 100 takes in the accelerator opening degree which is measured by the accelerator opening degree sensor 40. Next, in step S2, the control device 100 calculates the request charging efficiency based on the accelerator opening degree which is taken in, in step S1. Note that when the vehicle includes a cruise control device, the request charging efficiency may be calculated based on the request for acceleration from the control system thereof. Further, when the vehicle includes an autonomous drive device, the request charging efficiency may be calculated based on the request for acceleration from the control system thereof. Subsequently, in step S3, the control device 100 restricts the request charging efficiency calculated in step S2 by the upper limit charging efficiency, and thereby calculates the target charging efficiency which is realizable by the engine 1.

Next, in step S4, the control device 100 determines whether the present point of time is the point of time of start of the acceleration operation. The determination can be performed based on the accelerator opening degree and the changing speed thereof. Alternatively, when a deviation of a threshold value or more occurs between the request charging efficiency and the estimated all-gas charging efficiency due to increase in the request charging efficiency, a time point thereof may be regarded as the time point of start of the acceleration operation. A time point of end of the acceleration operation can be regarded as a time point at which the estimated all-gas charging efficiency catches up with the request charging efficiency and the difference thereof reaches the threshold value or less, for example.

When the present time point is determined as the time point of start of the acceleration operation in the determination in step S4, step S5 is selected. In step S5, the control device 100 predicts whether the increase speed of the charging efficiency of the EGR gas ever becomes higher than the increase speed of the charging efficiency of all the gases in the period of the acceleration operation, by the future prediction using the prediction model which will be described later. When a result of the determination in step S4 is negative, step S5 is skipped, and step S7 is selected as next processing. Therefore, determination in step S5 is performed only once at the time point of start of the acceleration operation, and thereafter, the determination in step S5 is not performed.

When it is predicted that the increase speed of the charging efficiency of the EGR gas becomes higher than the increase speed of the charging efficiency of all the gases in the determination in step S5, step S6 is selected. In step S6, the control device 100 determines to carry out correction of the target charging efficiency. When the determination is performed, a switching signal is inputted to the arithmetic operation unit 114 from the arithmetic operation unit 115 that configures the control device 100. When the result of the determination in step S5 is negative, step S6 is skipped, and step S7 is selected as next processing.

In step S7, the control device 100 determines presence or absence of correction of the target charging efficiency. When it is determined to carry out correction of the target charging efficiency in step S6, the determination result in step S7 is affirmative, and step S8 is selected. When the determination result in step S7 is negative, step S8 is skipped, and step S9 is selected.

In step S8, the control device 100 calculates the charging efficiency corresponding to the difference between the target EGR rate and the estimated EGR rate of the gas passing through the intake valve, and uses this charging efficiency as the charging efficiency correction amount to the target charging efficiency. That is, the control device 100 subtracts the charging efficiency correction amount from the target charging efficiency, and reduces the target charging efficiency by the charging efficiency correction amount. In the relationship with the claims of the present application, performing the processing in step S8 corresponds to selection of the second arithmetic operation, and skipping the processing in step S8 corresponds to selection of the first arithmetic operation.

Next, in step S9, the control device 100 calculates the target throttle opening degree corresponding to the target charging efficiency. The target charging efficiency for use in the calculation is the target charging efficiency corrected in step S8 when the correction processing in step S8 is performed, and is the target charging efficiency calculated in step S3 when the correction processing in step S8 is not performed. Subsequently, in step S10, the control device 100 controls the opening degree of the throttle 16 based on the target throttle opening degree calculated in step S9.

### 4. Operation of Engine in Case of Throttle Opening Degree Control being Executed

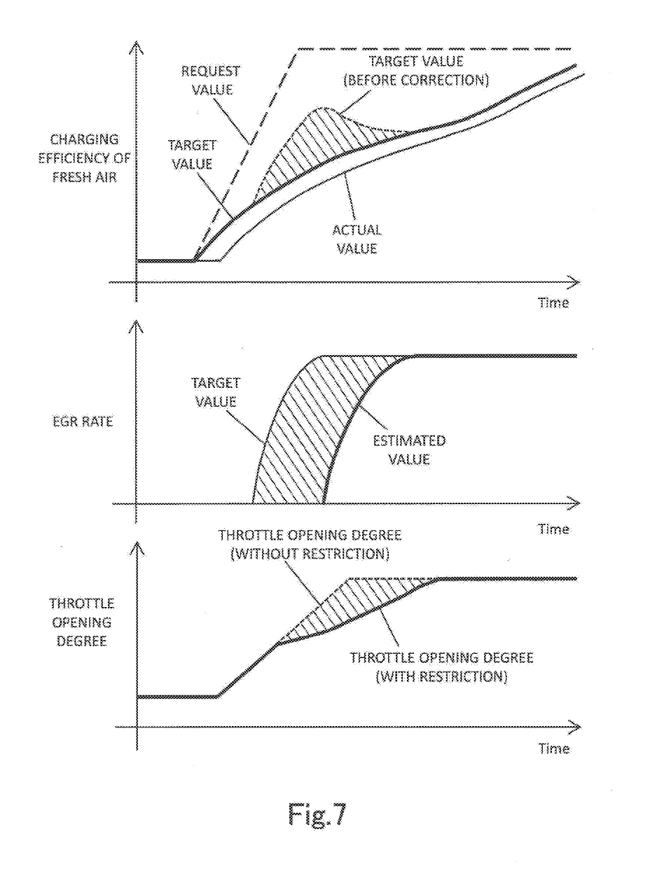

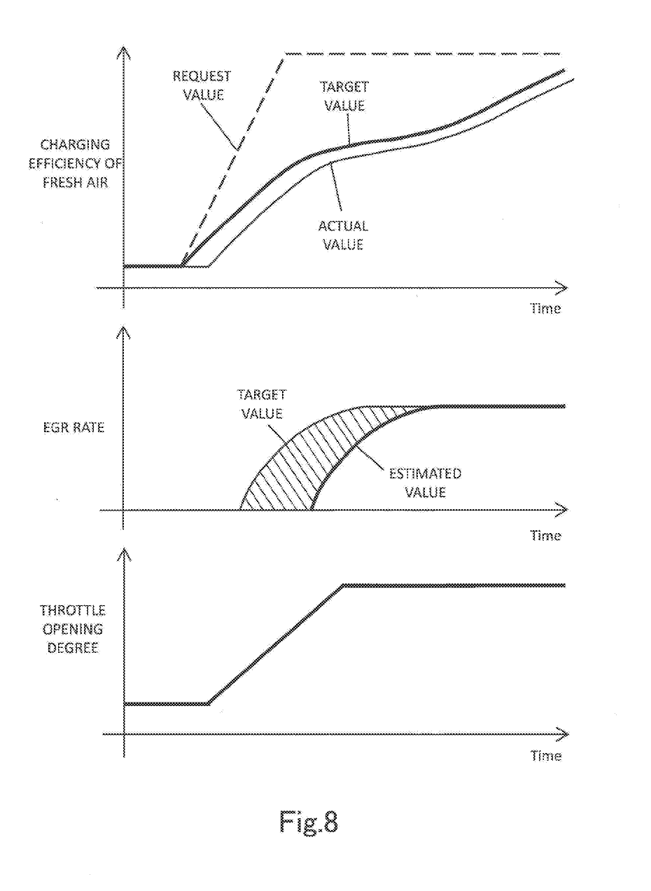

When the above described control flow is executed, at the time of acceleration from a low load with no EGR gas being introduced, the engine 1 is operated as illustrated in time charts in FIGS. 7 and 8, for example. The respective time charts illustrate changes with times of the charging efficiencies of fresh air, the EGR rates and the throttle opening degrees, in sequence from the top.

FIG. 7 illustrates an operation of the engine 1 as a result of throttle opening degree control which is adopted when it is predicted that the increase speed of the charging efficiency of the EGR gas becomes higher than the increase speed of the charging efficiency of all the gases.

In a time chart of the charging efficiency of fresh air, a broken line assigned with a label “request value” shows a change with time of the request charging efficiency. By restricting the request charging efficiency to a realistic value with the state of the engine 1 taken into consideration, the target charging efficiency (the target charging efficiency before correction) realizable by the engine 1 is determined. A curved line assigned with a label “target value (before correction)” shows the change with time of a proportion of the fresh air in the target charging efficiency before correction. A curved line assigned with a label “target value” shows a change with time of a proportion of the fresh air in the target charging efficiency after correction. A curved line assigned with a label “actual value” shows a change with time of the actual charging efficiency of the fresh air.

In a time chart of the EGR rate, a curved line assigned with a label of “target value” shows a change with time of the target EGR rate. A curved line assigned with a label of “estimated value” shows a change with time of the estimated EGR rate of the gas passing through the intake valve. When the target EGR rate and the estimated EGR rate change as illustrated in this time chart, according to the throttle opening degree control of the embodiment, the charging efficiency corresponding to the difference between the target EGR rate and the estimated EGR rate is calculated as the charging efficiency correction amount. The “target value” of the charging efficiency of the fresh air illustrated in the time chart in an upper tier is obtained by subtracting the charging efficiency correction amount from the “target value (before correction)” of the charging efficiency of the fresh air.

In the time chart of the throttle opening degree, the curved line assigned with a label of “throttle opening degree (without restriction)” shows a change with time of the throttle opening degree in a case of the target throttle opening degree being calculated based on the target charging efficiency before correction. The curved line assigned with a label of “throttle opening degree (with restriction)” shows a change with time of the throttle opening degree in a case of the target throttle opening degree being calculated based on the target charging efficiency after correction. The target charging efficiency corrected by the charging efficiency correction amount is used in calculation of the target throttle opening degree, whereby the target throttle opening degree is corrected to the closing side before and after the EGR gas reaches the combustion chamber. The throttle 16 is controlled based on the target throttle opening degree, whereby the increase speed of the throttle opening degree is restrained as shown by “throttle opening degree (with restriction)”. Thereby, the charging efficiency of the fresh air smoothly changes even before and after the EGR gas reaches the combustion chamber, and the torque level difference due to an arrival delay of the EGR gas is restrained.

FIG. 8 illustrates an operation of the engine 1 as a result of throttle opening degree control that is adopted when it is predicted that the increase speed of the charging efficiency of the EGR gas does not become higher than the increase speed of the charging efficiency of all the gases.

In a time chart of the charging efficiency of the fresh air, a broken line assigned with a label of “request value” shows a change with time of the request charging efficiency. A curved line assigned with a label of “target value” shows a change with time of a proportion of the fresh air in the target charging efficiency obtained by restricting the request charging efficiency to a realistic value with the state of the engine 1 taken into consideration. A curved line assigned with a label of “actual value” shows a change with time of an actual charging efficiency of the fresh air.

In a time chart of the EGR rate, a curved line assigned with a label of “target value” shows a change with time of the target EGR rate. A curved line assigned with a label of “estimated value” shows a change with time of the estimated EGR rate of a gas passing through the intake valve. When the change speed of the estimated EGR rate is low as illustrated in the time chart, the increase speed of the charging efficiency of the EGR gas is also low, and does not become higher than the increase speed of the charging efficiency of all the gases. In this case, according to the throttle opening degree control of the embodiment, correction of the target charging efficiency by the charging efficiency corresponding to the difference between the target EGR rate and the estimated EGR rate is not performed.

A curved line illustrated in a time chart of the target throttle opening degree shows a change with time of the throttle opening degree in a case of the target throttle opening degree being calculated based on the target charging efficiency. Correction to the target charging efficiency is not performed, whereby the throttle opening degree increases without the increase speed thereof being restrained. Thereby, the charging efficiency of the fresh air can be increased at the highest speed, and responsiveness of torque to the request for acceleration is ensured.

### 5. Configuration of Prediction Model

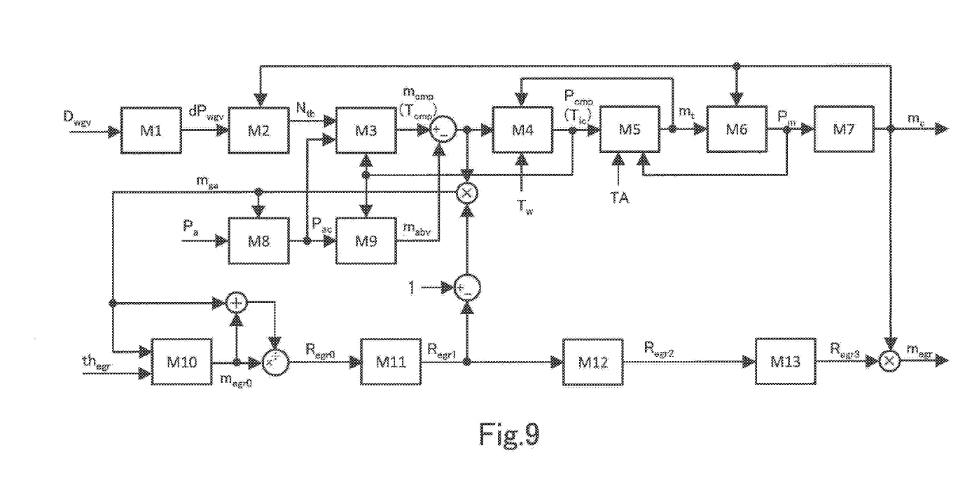

Next, a prediction model for use in prediction of the change speed of the charging efficiency of the fresh air will be described. FIG. 9 is a block diagram illustrating an example of a configuration of the prediction model. The prediction model is configured by a plurality of element models, that is, a wastegate valve response model M1, a turbo rotational speed model M2, a compressor model M3, an intercooler model M4, a throttle model M5, an intake manifold model M6, an intake valve model M7, an air cleaner model M8, an air bypass valve model M9, an EGR valve model M10 and EGR diffusion models M11, M12 and M13. FIG. 9 illustrates only main flows of information out of flows of information among the element models. Therefore, the flows of the information among the element models are not limited to the example illustrated in FIG. 9. Hereinafter, contents of the element models included by the prediction model will be described. However, these element models are all well known, and therefore, explanation concerning design matters such as mathematical expressions expressing the respective element models and maps will be omitted here.

The wastegate valve response model M1 is a model for calculating a diaphragm differential pressure “dP_{wgv}” of the wastegate valve 28 from an instruction opening degree “D_{wgv}” to the wastegate valve 28. The wastegate valve response model M1 is a model in which a response characteristic of the diaphragm differential pressure to the instruction opening degree is modeled, and is specifically expressed by a dead time element and a first order lag element. In the future prediction by the arithmetic operation unit 115, the instruction opening degree which is inputted to the wastegate valve response model M1 is full opening until the throttle opening degree is fully opened, and is switched to full closing after the throttle opening degree is fully opened. Note that if a response delay of the wastegate valve 28 is such a delay that is ignorable, the wastegate valve response model M1 may be omitted.

The turbo rotational speed model M2 is a model of a rotation behavior of the turbine 24. A difference between energy that is added to the turbine 24 and energy that is consumed by the compressor 22 is proportional to a change rate of the rotational speed of the turbine 24. Under the physical relationship, a relationship that is established between a flow rate of all the gasses passing through the intake valve (hereinafter, described as an intake valve flow rate), the diaphragm differential pressure of the wastegate valve 28 and the turbo rotational speed is modeled as the turbo rotational speed model M2. In the turbo rotational speed model M2, the diaphragm differential “dP_{wgv}” calculated in the wastegate valve response model M1, and an intake valve flow rate “m_{c}” calculated in the intake valve model M7 that will be described later are inputted, and a turbo rotational speed “N_{tb}” is calculated from the input information on them.

The compressor model M3 is a model in which a compression characteristic of the compressor 22 is modeled. A relationship that is established between a pressure ratio between the upstream side and the downstream side of the compressor 22, the turbo rotational speed, and a flow rate of a gas passing through the compressor 22 (hereinafter, described as a compressor flow rate) is modeled as the compressor model M3. In the compressor model M3, information on the turbo rotational speed “N_{tb}” that is calculated in the turbo rotational speed model M2, a supercharging pressure “P_{cmp}” that is calculated in the intercooler model M4 that will be described later, an air cleaner downstream pressure “P_{ac}” that is calculated in the air cleaner model M8 that will be described later and the like is inputted. From the input information on them, a compressor flow rate “m_{cmp}” is calculated, and a compressor downstream temperature “T_{cmp}” is calculated.

The intercooler model M4 is a physical model that is constructed based on a conservation law concerning gas in the intercooler 14 in the intake passage 4. As the intercooler model M4, a formula of an energy conservation law and a formula of a flow rate conservation law are specifically used. In the intercooler model M4, information on a flow rate obtained by subtracting an air bypass valve flow rate (a flow rate of gas passing through an air bypass valve) “m_{abv}” that is calculated in the air bypass valve model M9 that will be described later, from the compressor flow rate “m_{cmp}” that is calculated in the compressor model M3, the compressor downstream temperature “T_{cmp}” calculated in the compressor model M3, a throttle flow rate (a flow rate of gas passing through the throttle 16) “mₜ” that is calculated in the throttle model M5 that will be described later and the like is inputted. From the input information on them, a supercharging pressure “p_{cmp}” is calculated, and an intercooler outlet temperature “T_{ic}” is calculated.

The throttle model M5 is a model for calculating a throttle flow rate from the throttle opening degree. Specifically, a throttle formula (or also referred to as an orifice flow rate formula) that has a pressure ratio between the upstream side and the downstream side of the throttle 16, an upstream temperature of the throttle 16, a passage area determined by the throttle opening degree, and a flow rate coefficient as parameters is used as the throttle model M5. In the throttle model M5, information on the supercharging pressure “P_{cmp}” and the intercooler outlet temperature “T_{ic}” that are calculated in the intercooler model M4, an intake manifold pressure “Pₘ” that is calculated in the intake manifold model M6 that will be described later and the like is inputted. Further, a throttle opening degree “TA” in a case where correction of the target charging efficiency is not performed, which is predicted separately, is inputted to the throttle model M5. Subsequently, a throttle flow rate “mₜ” is calculated from the input information on them.

The intake manifold model M6 is a physical model that is constructed based on a conservation rule concerning air in the intake manifold. As the intake manifold model M6, a formula of an energy conservation law and a formula of a flow rate conservation law are specifically used. In the intake manifold model M6, information on the throttle flow rate “mₜ” calculated in the throttle model M5, an intake valve flow rate “m_{c}” that is calculated in the intake valve model M7 that will be described later and the like is inputted, and the intake manifold pressure “Pₘ” is calculated from input information on them.

The intake valve model M7 is a model based on an experimental result of investigating a relationship between the intake valve flow rate and the intake manifold pressure. By an empirical rule obtained by an experiment, the relationship between the intake valve flow rate and the intake manifold pressure is approximated by a broken line (or a straight line) that monotonously changes in the intake valve model M7. A coefficient of an equation of the broken line (or the straight line) is not a constant, but a variable that is determined by the engine speed or the like. In the intake valve model M7, information on the engine speed and the like is inputted, in addition to the intake manifold pressure “Pₘ” that is calculated in the intake manifold model M6, and the intake valve flow rate “m_{c}” is calculated from the input information on them. Subsequently, the intake valve flow rate “m_{c}” is converted into a flow rate per one cycle by using the engine speed, and a ratio to a mass of air corresponding to a stroke volume is calculated, whereby the charging efficiency of all the gases is calculated. In the calculation, a present value of the engine speed may be used.

The air cleaner model M8 is a model for calculating a pressure loss that occurs in the air cleaner 10. The air cleaner model M8 calculates a value obtained by subtracting a pressure loss from the atmospheric pressure “Pₐ” as the air cleaner downstream pressure “P_{ac}”. For the atmospheric pressure “Pₐ”, a standard atmospheric pressure stored in the memory of the ECU may be used as a preset value, or a value of the atmospheric pressure under each situation measured by the atmospheric pressure sensor may be used. The pressure loss can be calculated from a flow rate of fresh air that passes through the air cleaner 10. A flow rate “m_{ga}” of the fresh air that passes through the air cleaner 10 can be roughly calculated by correcting a flow rate that is obtained by subtracting the air bypass valve flow rate “m_{abv}” from the compressor flow rate “m_{cmp}” by an EGR rate “R_{egr1}” in the outlet of the compressor 22. If the pressure loss of the air cleaner 10 is such a degree as to be ignorable, the air cleaner model M8 may be omitted.

The air bypass valve model M9 is a model for calculating a flow rate of a gas that is returned to an upstream side from the downstream side of the compressor 22 by the air bypass valve not illustrated. As the air bypass valve model M9, a throttle formula is used as in the throttle model M5. In the air bypass valve model M9, information on the air cleaner downstream pressure “P_{ac}” that is calculated in the air cleaner model M8, the supercharging pressure “P_{cmp}” that is calculated in the intercooler model M4, an opening degree of the air bypass valve and the like is inputted, and from the input information on them, the air bypass valve flow rate “m_{abv}” is calculated. When the engine 1 does not include an air bypass valve, the air bypass valve model M9 is omitted.

The EGR valve model M10 is a model for calculating the flow rate (hereinafter, described as the EGR valve flow rate) of the EGR gas that passes through the EGR valve 34. As a formula for calculating the EGR valve flow rate, a throttle formula can be used as in the throttle model M5 and the air bypass valve model M9. However, the upstream pressure and the downstream pressure of the EGR valve 34 both depend on the flow rate of fresh air, and therefore, the EGR valve flow rate can be expressed by a function (a function obtained by modifying the throttle formula) of the opening degree of the EGR valve 34 and the flow rate of the fresh air. In the EGR valve model M10, based on the flow rate “m_{egr}” of fresh air and an opening degree “th_{egr}” of the EGR valve 34, the EGR valve flow rate “m_{egr}” is calculated from the aforementioned function. For the EGR valve opening degree “th_{egr}”, a value determined based on the charging efficiency calculated from the intake valve flow rate “m_{c}” is used. By calculating a ratio of the EGR valve flow rate “m_{egr}” calculated in the EGR valve model M10, and a flow rate obtained by adding the EGR valve flow rate “m_{egr}” to the flow rate “m_{ga}” of fresh air, an EGR rate “R_{egr0}” in the outlet of the EGR valve 34 is obtained.

The EGR diffusion model M11 is a model in which a change with time of the EGR rate by diffusion of EGR gas in the compressor 22 is modeled, and is specifically expressed by a dead time element and a first order lag element. The dead time is a time necessary for gas to pass through the compressor 22, and is related to the upstream temperature, the upstream pressure and the flow rate of fresh air of the compressor 22. A time constant of the first order lag element is a parameter indicating a degree of diffusion of the EGR gas in the compressor 22, and is related to the flow rate of fresh air. In the EGR diffusion model M11, the EGR rate “R_{egr0}” in the outlet of the EGR valve 34 is processed with the dead time element and the first order lag element, whereby the EGR rate “R_{egr1}” in the outlet of the compressor 22 is calculated.

The EGR diffusion model M12 is a model in which a change with time of the EGR rate by diffusion of the EGR gas in the throttle 16 is modeled, and is specifically expressed by a dead time element and a first order lag element. A dead time is a time that is necessary for gas to pass through the throttle 16, and is related to the upstream temperature, the upstream pressure and the flow rate of fresh air of the throttle 16. A time constant of the first order lag element is a parameter indicating a degree of diffusion of the EGR gas in the throttle 16, and is related to the flow rate of fresh air. In the EGR diffusion model M12, the EGR rate “R_{egr1}” in the outlet of the compressor 22 is processed with the dead time element and the first order lag element, whereby the EGR rate “R_{egr2}” in the outlet of the throttle 16 is calculated.

The EGR diffusion model M13 is a model in which a change with time of the EGR rate by diffusion of the EGR gas in the intake valve is modeled, and is specifically expressed by a dead time element and a first order lag element. A dead time is a time that is necessary for gas to pass through the intake valve, and is related to an upstream temperature, an upstream pressure and a flow rate of fresh air of the intake valve. A time constant of the first order lag element is a parameter indicating a degree of diffusion of the EGR gas in the intake valve, and is related to the flow rate of fresh air. In the EGR diffusion model M13, the EGR rate “R_{egr2}” in the outlet of the throttle 16 is processed with the dead time element and the first order lag element, whereby the EGR rate “R_{egr3}” in the outlet of the intake valve is calculated. Note that the three EGR diffusion models M11, M12 and M13 may be combined into one, and configured as a single EGR diffusion model.

By multiplying the intake valve flow rate “m_{c}” that is calculated in the intake valve model M7 by the EGR rate “R_{egr3}” calculated in the EGR diffusion model M13, a flow rate “m_{egr}” of the EGR gas passing through the intake valve is calculated. Subsequently, the flow rate “m_{egr}” of the EGR gas is converted into a flow rate per one cycle by using the engine speed, and a ratio to a mass of air corresponding to the stroke volume is calculated, whereby the charging efficiency of the EGR gas is calculated.

The arithmetic operation unit 115 of the control device 100 repeats calculation by the prediction model configured as above by a number of times corresponding to a prediction period. When a divided time period of prediction is set as Δt, calculation by the prediction model is repeated by the number of times obtained by dividing the prediction period by the time period Δt. However, the time period Δt is only a parameter in calculation, and is not an actual time period. The control device 100 executes repetitive calculation of the number of times corresponding to the prediction period, in a single arithmetic operation period.

In calculation by the prediction model, a series of calculations shown below is performed at processing of each time. First, an outline of calculation for predicting the increase speed of the charging efficiency of all the gases is as follows.

(a1) From the change speed of the throttle opening degree, the throttle opening degree “TA” of the future by the time period Δt is predicted.
(a2) From the throttle opening degree “TA”, the intake manifold pressure “Pₘ” of the future by the time period Δt is predicted by using the throttle model M5 and the intake manifold model M6.
(a3) From the intake manifold pressure “Pₘ”, the intake valve flow rate “m_{c}” of the future by the time period Δt is predicted by using the intake valve model M7.
(a4) From the intake valve flow rate “m”, the turbo rotational speed “N_{tb}” of the future by the time period Δt is predicted by using the turbo rotational speed model M2.
(a5) From the turbo rotational speed “N_{tb}”, the compressor flow rate “m_{cmp}” and the compressor downstream temperature “T_{cmp}” of the future by the time period Δt are calculated by using the compressor model M3.
(a6) From the compressor flow rate “m_{cmp}” and the compressor downstream temperature “T_{cmp}”, the supercharging pressure “P_{cmp}” and the intercooler outlet temperature “T_{ic}” of the future by the time period Δt are calculated by using the intercooler model M4.

A series of calculations of the above is performed by processing of one time, and the intake valve flow rate “m_{c}” of the future by the time period Δt is calculated at the processing of each time. Subsequently, from the intake valve flow rate “m_{c}”, the charging efficiency of all the gases is calculated, and the increase speed of the charging efficiency of all the gases is calculated from a difference between the value of this time and a value of a previous time of the charging efficiency of all the gases. The supercharging pressure “P_{cmp}” and the intercooler outlet port temperature “T_{ic}” which are calculated in (a6) in the end are used as inputs to the throttle model M5 in processing of a next time.

Next, an outline of calculation for predicting the increase speed of the charging efficiency of the EGR gas is as follows.

(b1) From the change speed of the throttle opening degree, the throttle opening degree “TA” of the future by the time period Δt is predicted.
(b2) From the throttle opening degree “TA”, the intake manifold pressure “Pₘ” of the future by the time period Δt is predicted by using the throttle model M5 and the intake manifold model M6.
(b3) From the intake manifold pressure “Pₘ”, the intake valve flow rate “m_{c}” of the future by the time period Δt is predicted by using the intake valve model M7.
(b4) From the intake valve flow rate “m_{c}”, the turbo rotational speed “N_{tb}” of the future by the time period Δt is predicted by using the turbo rotational speed model M2.
(b5) From the turbo rotational speed “N_{tb}”, the compressor flow rate “m_{cmp}” and the compressor downstream temperature “T_{cmp}” of the future by the time period Δt are calculated by using the compressor model M3.
(b6) From the compressor flow rate “m_{cmp}”, the flow rate “m_{ga}” of fresh air of the future by the time period Δt is calculated.
(b7) From the flow rate “m_{ga}” of fresh air, the flow rate “m_{egr}” of the EGR gas of the future by the time period Δt is calculated by using the EGR valve model M10 and the EGR diffusion models M11, M12 and M13.

A series of calculations in the above is performed by processing of one time, and the flow rate “m_{c},” of the EGR gas of the future by the time period Δt is calculated at the processing of each time. Subsequently, from the flow rate “m_{egr}” of the EGR gas, the charging efficiency of the EGR gas is calculated, and from a difference between a value of this time and a value of a previous time of the charging efficiency of the EGR gas, the increase speed of the charging efficiency of the EGR gas is calculated.

The arithmetic operation unit 115 of the control device 100 compares the increase speed of the charging efficiency of all the gases calculated in this way, and the increase speed of the charging efficiency of the EGR gas at each time. As described above, when the increase speed of the charging efficiency of the EGR gas becomes larger than the increase speed of the charging efficiency of all the gases, the increase speed of the charging efficiency of fresh air becomes negative, and therefore it can be predicted that temporary reduction occurs to the charging efficiency of fresh air.

### 6. Another Example of Configuration of Prediction Model

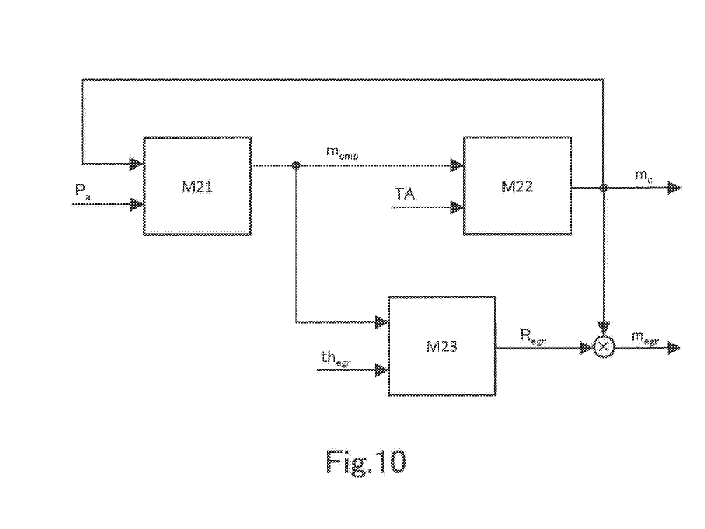

FIG. 10 is a block diagram illustrating another example of a configuration of a prediction model for use in prediction of the change speed of the charging efficiency of fresh air. The prediction model is a model that is simplified more than the prediction model illustrated in FIG. 9, and is configured by three element models, that is, a supercharging model M21, an intake model M22 and an EGR model M23. FIG. 10 describes only main flows of information out of flows of information among the element models. Therefore, the flows of the information among the element models are not limited to the example illustrated in FIG. 10. Hereinafter, contents of the three element models included by the prediction model will be described.

The supercharging model M21 is a model in which a relationship between the intake valve flow rate, the atmospheric pressure and the compressor flow rate is modeled, and corresponds to what is obtained by integrating the turbo rotational speed model M2 and the compressor model M3 in the prediction model illustrated in FIG. 9. The compressor flow rate can be expressed by a function having the intake valve flow rate and the atmospheric pressure as variables. In the supercharging model M21, the intake valve flow rate “m_{c}” calculated in the intake model M22 that will be described later and the atmospheric pressure “Pₐ” are inputted, and the compressor flow rate “m_{cmp}” is calculated by using the aforementioned function. A fixed value may be used as the atmospheric pressure. In that case, the compressor flow rate can be expressed by a function having only the intake valve flow rate as a variable.

The intake model M22 is a model in which a relationship between the compressor flow rate, the throttle opening degree and the intake valve flow rate is modeled, and corresponds to what is obtained by integrating the intercooler model M4, the throttle model M5, the intake manifold model M6 and the intake valve model M7 in the prediction model illustrated in FIG. 9. The intake valve flow rate can be expressed by a function having the compressor flow rate and the throttle opening degree as variables. In the intake model M22, the compressor flow rate “m_{cmp}” that is calculated in the supercharging model M21, and the throttle opening degree “TA” in the case of not performing correction of the target charging efficiency, which is predicted separately, are inputted, and the intake valve flow rate “m_{c}” is calculated by using the aforementioned function. Subsequently, the intake valve flow rate “m_{c}” is converted into the flow rate per one cycle by using the engine speed, and a ratio to a mass of air corresponding to the stroke volume is calculated, whereby the charging efficiency of all the gases can be calculated.

The EGR model M23 is a model in which a relationship between the compressor flow rate, the EGR valve opening degree and the EGR rate is modeled, and corresponds to what is obtained by integrating the EGR valve model M10, the EGR diffusion models M11, M12 and M13 in the prediction model illustrated in FIG. 9. The EGR rate can be expressed by a function having the compressor flow rate and the EGR valve opening degree as variables. In the EGR model M23, the compressor flow rate “m_{cmp}” calculated in the supercharging model M21, and the EGR valve opening degree “th_{egr}” that is separately predicted are inputted, and the EGR rate “R_{egr}” is calculated by using the aforementioned function.

By multiplying the intake valve flow rate “m_{c}” calculated in the intake model M22 by the EGR rate “R_{egr}” calculated in the EGR model M23, the flow rate “m_{egr}” of the EGR gas that passes through the intake valve is calculated. Subsequently, the flow rate “m_{egr}” of the EGR gas is converted into the flow rate per one cycle by using the engine speed, the ratio to a mass of air corresponding to the stroke volume, whereby the charging efficiency of the EGR gas is calculated.

If the increase speed of the charging efficiency of all the gases and the increase speed of the charging efficiency of the EGR gas can be respectively predicted based on the throttle opening degree in the case of not performing correction of the target charging efficiency, the prediction model which is simplified as illustrated in FIG. 10 may be used.

### 7. Other Embodiments

As the second arithmetic operation by which the increase speed of the throttle opening degree is restrained more than by the first arithmetic operation, restricting the change amount per one control period of the target throttle opening degree with a guard value may be adopted. The guard value in that case may be a fixed value, or may be a function having a difference between the target EGR rate and the estimated EGR rate as a variable.

What is claimed is:

1. A control device for an internal combustion engine having a compressor disposed in an intake passage, a throttle disposed downstream from the compressor in the intake passage, and an EGR valve disposed in an EGR passage connecting an exhaust passage and an upstream side from the compressor in the intake passage, which is configured to operate the throttle so as to increase a charging efficiency of an in-cylinder gas, and operate the EGR valve to increase an EGR rate of the in-cylinder gas, in an acceleration operation, the control device comprising:
at least one processor; and
at least one memory including at least one computer program, the at least one memory and the at least one computer program configured, with the at least one processor, to cause the control device at least to operate as:
target charging efficiency determination means for determining a target charging efficiency, the target charging efficiency determination means being configured to increase the target charging efficiency in accordance with a magnitude of acceleration requested of the internal combustion engine;
target throttle opening degree arithmetic operation means for calculating a target throttle opening degree based on the target charging efficiency, the target throttle opening degree arithmetic operation means being configured to select to calculate the target throttle opening degree by a first arithmetic operation, and to calculate the target throttle opening degree by a second arithmetic operation by which an increase speed of a throttle opening degree is restrained more than by the first arithmetic operation; and
prediction means for predicting whether temporary reduction occurs to a charging efficiency of fresh air in the in-cylinder gas by an influence of the EGR rate of the in-cylinder gas which increases later than increase of the charging efficiency of the in-cylinder gas if the first arithmetic operation is applied to calculation of the target throttle opening degree based on the target charging efficiency which is increasing, in a case of shifting to the acceleration operation, by using a prediction model expressing dynamic characteristics of the internal combustion engine,
wherein the target throttle opening degree arithmetic operation means is configured to
select to calculate the target throttle opening degree by the first arithmetic operation when the prediction means does not predict that the temporary reduction occurs to the charging efficiency of the fresh air in the in-cylinder gas, and
select to calculate the target throttle opening degree by the second arithmetic operation when the prediction means predicts that temporary reduction occurs to the charging efficiency of the fresh air in the in-cylinder gas.

2. The control device for an internal combustion engine according to claim 1,
wherein the prediction means is configured to
predict an increase speed of the charging efficiency of the in-cylinder gas, and an increase speed of a charging efficiency of an EGR gas in the in-cylinder gas, that are obtained when the throttle is operated by using the target throttle opening degree calculated by the first arithmetic operation, by using the prediction model, and
determine that temporary reduction occurs to the charging efficiency of the fresh air in the in-cylinder gas when the increase speed of the charging efficiency of the EGR gas in the in-cylinder gas is higher than the increase speed of the charging efficiency of the in-cylinder gas.

3. The control device for an internal combustion engine according to claim 1,
wherein the target throttle opening degree arithmetic means is configured to
calculate a throttle opening degree for achieving the target charging efficiency as the target throttle opening degree, in the first arithmetic operation, and
acquire a target EGR rate, calculate an estimated EGR rate of all gases passing through an intake valve, correct the target charging efficiency by subtracting a charging efficiency corresponding to a difference between the target EGR rate and the estimated EGR rate from the target charging efficiency, and calculate a throttle opening degree for achieving the corrected target charging efficiency as the target throttle opening degree, in the second arithmetic operation.
